(19) United States
(12) Patent Application Publication
(10) Pub. No.: US 2025/0322493 A1
(43) Pub. Date: Oct. 16, 2025

(54) IMAGE PROCESSING DEVICE, IMAGE PROCESSING METHOD, AND IMAGE PROCESSING PROGRAM

(71) Applicant: NIPPON TELEGRAPH AND TELEPHONE CORPORATION, Tokyo (JP)

(72) Inventors: Yuya OMORI, Tokyo (JP); Ken NAKAMURA, Tokyo (JP); Daisuke KOBAYASHI, Tokyo (JP); Shuhei YOSHIDA, Tokyo (JP); Saki HATTA, Tokyo (JP); Hiroyuki UZAWA, Tokyo (JP)

(73) Assignee: NIPPON TELEGRAPH AND TELEPHONE CORPORATION, Tokyo (JP)

(21) Appl. No.: 18/869,902

(22) PCT Filed: Jun. 7, 2022
(86) PCT No.: PCT/JP2022/022961

§ 371 Date: Nov. 27, 2024

(51) Int. Cl. G06T 5/20; G06V 10/75

(52) U.S. Cl. CPC G06T 5/20; G06V 10/751; G06T 2207/20084

(57) ABSTRACT

When convolution processing is performed, an input feature map to be an input of the convolution processing is divided into small regions, and in a case where features constituting the small region correspond to a predetermined feature or a feature of a small region processed in past, the convolution processing is not performed for the small region, and a result of processing for the predetermined feature or a result of processing in past is output as a processing result for the small region.

### TECHNICAL FIELD

The technology of the present disclosure relates to an image processing device, an image processing method, and an image processing program.

### BACKGROUND ART

In a case where inference using a convolutional neural network (CNN) is performed, the network is constituted by a plurality of layers, and convolution processing is performed in a convolutional layer. The convolution processing includes a product-sum operation and activation processing.

In inference using a CNN, the convolution operation described above accounts for a large portion of the entire processing amount.

In a case where an inference engine using a CNN as hardware is implemented, performance of the convolution operation is directly linked to the performance of the entire engine.

FIGS. 25 and 26 illustrate examples of the convolution operation in a case where the kernel size is 3×3. FIG. 25 illustrates an example in which a convolution operation is performed on a 3×3 input feature map using a 3×3 kernel. In this example, nine product-sum operations are performed to output a 1×1 output feature map.

Furthermore, FIG. 26 illustrates an example in which a convolution operation is performed on a (W+2)×(H+2) input feature map using a 3×3 kernel. In this example, nine product-sum operations are repeated while the kernel is moved on the input feature map, and a W×H output feature map is output.

In hardware that performs a convolution operation of a CNN, in order to increase throughput, a circuit is often prepared so that the input feature map is divided into small regions of a certain fixed size and a product-sum operation for one small region can be performed at a time (see FIG. 27). FIG. 27 illustrates an example in which a 26×14 input feature map is divided into nine 10×6 small regions, and an arithmetic circuit performs convolution processing at 32 points (8×4 points) simultaneously using a 3×3 kernel and outputs an 8×4 output feature map. In this example, a dot part of the input feature map is one small region, and the arithmetic circuit performs 32-point simultaneous convolution processing on each of the nine small regions, thereby outputting a 24×12 output feature map.

Furthermore, as one of calculation speedup methods, as illustrated in FIG. 28, a method of skipping the calculation in a case where values of a small region of the input feature map are all 0 is known (see Non Patent Literature 1, for example). FIG. 28 illustrates an example of a case where the size of the output small region is 4×2, the kernel size is 3×3, and 4-bit data representing 0 to 15 is used. In this example, the size of the small region of the input feature map is 6×4, and values of the small region indicated by the dotted line are all 0. Since the result of product-sum operation with respect to 0 is 0, it is not necessary to perform the convolution processing by the arithmetic circuit, and the convolution processing on the small region can be skipped.

### CITATION LIST

### Non Patent Literature

Non Patent Literature 1: Angshuman Parashar, Minsoo Rhu, Anurag Mukkara, Antonio Puglielli, Rangharajan Venkatesan, Brucek Khailany, Joel Emer, Stephen W. Keckler, William J. Dally, “SCNN: An Accelerator for Compressed-sparse Convolutional Neural Networks”, arXiv: 1708.04485, 23 May 2017

### SUMMARY OF INVENTION

### Technical Problem

Here, in a case where an attempt is made to increase the size of the small region in order to increase throughput, there will be less cases where all the values of the small region of the input feature map are 0, and a sufficient calculation speedup cannot be expected. For example, as illustrated in FIG. 29A, in a case where the size of the small region of the output feature map is 4×2 (case where size of small region of input feature map is 6×4), values of the small region indicated by the dotted line of the input feature map are all 0. On the other hand, as illustrated in FIG. 29B, in a case where the size of the small region of the output feature map is 8×4 (case where size of small region of input feature map is 10×6), a non-zero value is included in the small region indicated by the dotted line of the input feature map.

Furthermore, the size of the small region is directly linked to calculation throughput, and therefore is difficult to change in many cases.

The disclosed technology has been made in view of the above points, and an object thereof is to provide an image processing device, an image processing method, and an image processing program capable of speeding up processing using a neural network including convolution processing.

### Solution to Problem

A first aspect of the present disclosure provides an image processing device including a neural network including convolution processing for an image, the image processing device including: an acquisition unit that acquires a target image to be processed; and a processing unit that processes the target image using the neural network including the convolution processing, in which the processing unit, when performing the convolution processing, performs the convolution processing for each small region obtained by dividing an input feature map to be an input of the convolution processing, when the convolution processing is performed for each small region, in a case where features constituting the small region correspond to a predetermined feature or a feature of a small region processed in past, the convolution processing is not performed for the small region, and a result of processing for the predetermined feature or a result of processing in past is output as a processing result for the small region, the small region corresponding to the predetermined feature is the small region in which a difference from the predetermined feature is equal to or less than a threshold, and the small region corresponding to the feature of the small region processed in the past is the small region in which a difference from the feature of the small region processed in the past is equal to or less than a threshold.

A second aspect of the present disclosure provides an image processing method in an image processing device including a neural network including convolution processing for an image, the image processing method including: acquiring, by an acquisition unit, a target image to be processed; and processing, by a processing unit, the target image by using the neural network including the convolution processing, in which when the processing unit performs the convolution processing, the processing unit performs the convolution processing for each small region obtained by dividing an input feature map to be an input of the convolution processing, when the convolution processing is performed for each small region, in a case where features constituting the small region correspond to a predetermined feature or a feature of a small region processed in past, the convolution processing is not performed for the small region, and a result of processing for the predetermined feature or a result of processing in past is output as a processing result for the small region, the small region corresponding to the predetermined feature is the small region in which a difference from the predetermined feature is equal to or less than a threshold, and the small region corresponding to the feature of the small region processed in the past is the small region in which a difference from the feature of the small region processed in the past is equal to or less than a threshold.

A third aspect of the present disclosure provides an image processing program for causing a computer including a neural network including convolution processing for an image to execute: acquisition of a target image to be processed; and processing of the target image using the neural network including the convolution processing, in which when the convolution processing is performed, the convolution processing is performed for each small region obtained by dividing an input feature map to be an input of the convolution processing, when the convolution processing is performed for each small region, in a case where features constituting the small region correspond to a predetermined feature or a feature of a small region processed in past, the convolution processing is not performed for the small region, and a result of processing for the predetermined feature or a result of processing in past is output as a processing result for the small region, the small region corresponding to the predetermined feature is the small region in which a difference from the predetermined feature is equal to or less than a threshold, and the small region corresponding to the feature of the small region processed in the past is the small region in which a difference from the feature of the small region processed in the past is equal to or less than a threshold.

### Advantageous Effects of Invention

According to the disclosed technology, processing using a neural network including convolution processing can be speeded up.

### BRIEF DESCRIPTION OF DRAWINGS

FIG. 1 is a diagram for illustrating a small region of an input feature map.

FIG. 2 is a diagram for illustrating a method of skipping convolution processing for a small region of an input feature map.

FIG. 3 is a diagram for illustrating a small region of an input feature map.

FIG. 4A is a diagram for illustrating a method of determining a small region as a small region including identical values.

FIG. 4B is a diagram for illustrating a method of determining a small region as a small region that is sequentially the same.

FIG. 5 is a diagram for illustrating a method of determining a small region as a small region including identical values.

FIG. 6 is a diagram for illustrating a method of determining a small region as a small region that is sequentially the same.

FIG. 7 is a schematic block diagram of an example of a computer that functions as an image processing device according to a first embodiment, a second embodiment, and a third embodiment.

FIG. 8 is a block diagram illustrating a functional configuration of the image processing device according to the first embodiment, the second embodiment, and the third embodiment.

FIG. 9 is a block diagram illustrating a functional configuration of a learning unit of the image processing device according to the first embodiment, the second embodiment, and the third embodiment.

FIG. 10 is a block diagram illustrating a functional configuration of an inference unit of the image processing device according to the first embodiment, the second embodiment, and the third embodiment.

FIG. 11 is a flowchart illustrating a flow of learning processing according to the first embodiment, the second embodiment, and the third embodiment.

FIG. 12 is a flowchart illustrating a flow of convolution processing in learning processing and image processing according to the first embodiment, the second embodiment, and the third embodiment.

FIG. 13 is a flowchart illustrating a processing flow of determining whether a region is a small region including identical values according to the first embodiment.

FIG. 14 is a flowchart illustrating a processing flow of determining whether a region is a small region that is sequentially the same according to the first embodiment.

FIG. 15 is a flowchart illustrating a processing flow of determining whether a region is a small region including identical values according to the first embodiment.

FIG. 16 is a flowchart illustrating a processing flow of determining whether a region is a small region that is sequentially the same according to the first embodiment.

FIG. 17 is a flowchart illustrating a flow of image processing according to the first embodiment, the second embodiment, and the third embodiment.

FIG. 18 is a flowchart illustrating a processing flow of determining whether a region is a small region including identical values according to the second embodiment.

FIG. 19 is a flowchart illustrating a processing flow of determining whether a region is a small region that is sequentially the same according to the second embodiment.

FIG. 20 is a diagram for illustrating a method of performing convolution processing in accordance with a determination result for a small region.

FIG. 21 is a diagram for illustrating a method of performing convolution processing on a plurality of small regions in parallel.

FIG. 22 is a diagram for illustrating a method of skipping convolution processing for a small region of an input feature map in a modification.

FIG. 23 is a diagram for illustrating a method of skipping convolution processing for a small region of an input feature map in a modification.

FIG. 24 is a diagram for illustrating a method of skipping convolution processing for a small region of an input feature map in a modification.

FIG. 25 is a diagram illustrating an example of convolution processing.

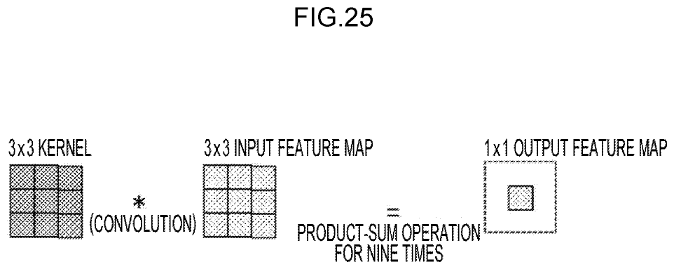

FIG. 26 is a diagram illustrating an example of convolution processing.

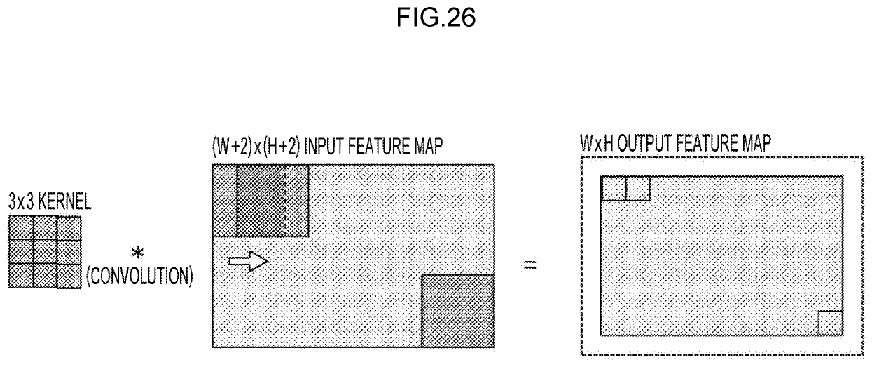

FIG. 27 is a diagram illustrating an example of convolution processing for each small region.

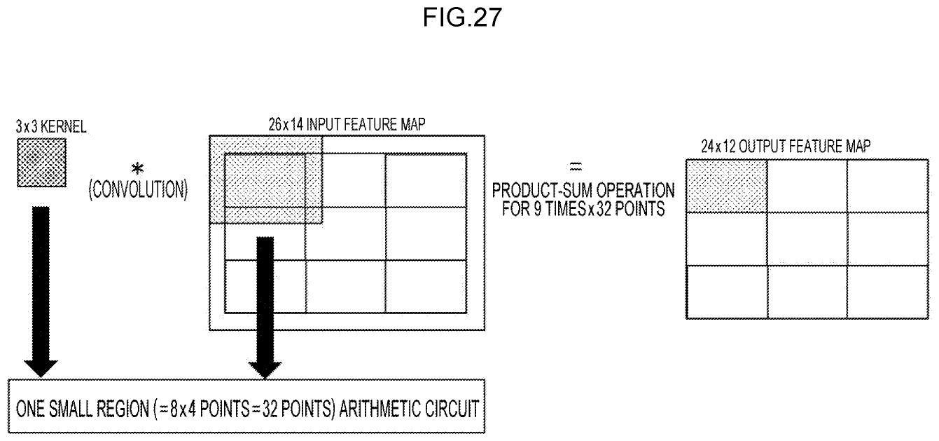

FIG. 28 is a diagram illustrating an example of a small region of an input feature map.

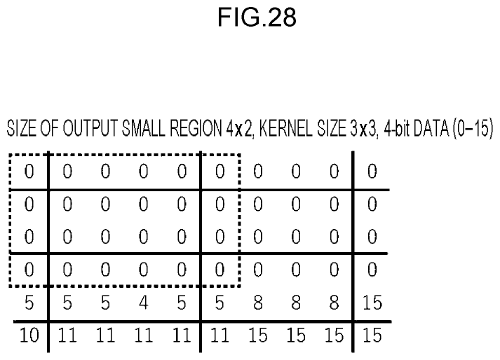

FIG. 29A is a diagram illustrating an example of a small region of an input feature map.

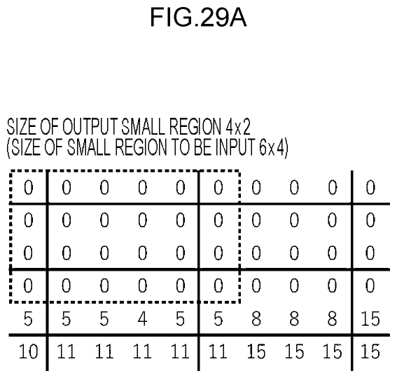

FIG. 29B is a diagram illustrating an example of a small region of an input feature map.

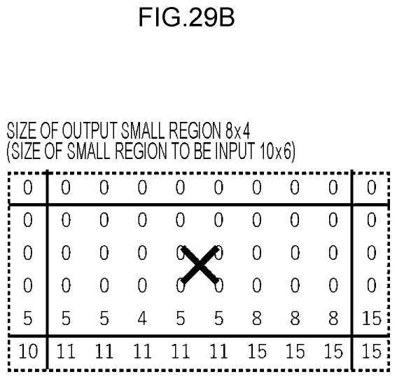

### DESCRIPTION OF EMBODIMENTS

Hereinafter, an example of an embodiment of the disclosed technology will be described with reference to the drawings. In the drawings, the same or equivalent components and portions are denoted by the same reference signs. Further, dimensional ratios in the drawings are exaggerated for convenience of description and may be different from actual ratios.

### Overview of Embodiments of Disclosed Technology

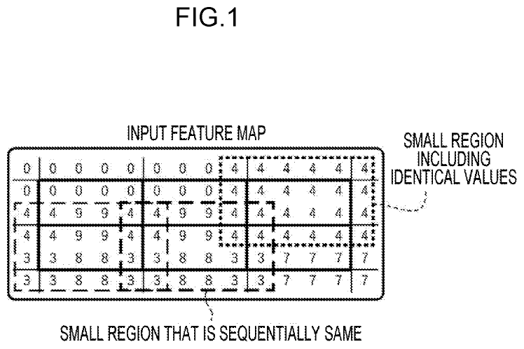

In the disclosed technology, data of an input feature map of a convolutional layer is read from a random access memory (RAM) or the like, and then it is determined for each small region whether the small region is a small region in which all features in the small region are identical values and whether the small region is a small region that is sequentially the same. Hereinafter, a small region of an input feature map in which all features inside the small region are the same is referred to as a “small region including identical values”. Furthermore, a small region in which features in the small region are completely the same as those in the previous small region is referred to as a “small region that is sequentially the same”. As an example of the “small region including identical values”, FIG. 1 illustrates an example in which all features in a small region surrounded by the dotted line are 4. Furthermore, as an example of the “small region that is sequentially the same”, an example is illustrated in which features in a small region surrounded by a thin broken line and features in a small region surrounded by a thick broken line are the same. Here, the reason why it is determined whether a region is a small region including identical values is that the values are identical also in an input image in many cases. Furthermore, the reason why it is determined whether a region is a small region that is sequentially the same is that similar regions exist in sequence also in an input image in many cases. For example, there is a case where the value of 10 points in the upper first row of a 10×6 region of the input image is 10 and the value of 50 points in the lower third row is 12. Both a region including identical values and a small region that is sequentially the same apply to a case where the input image is not a region of a complicated picture but a flat and uniform region.

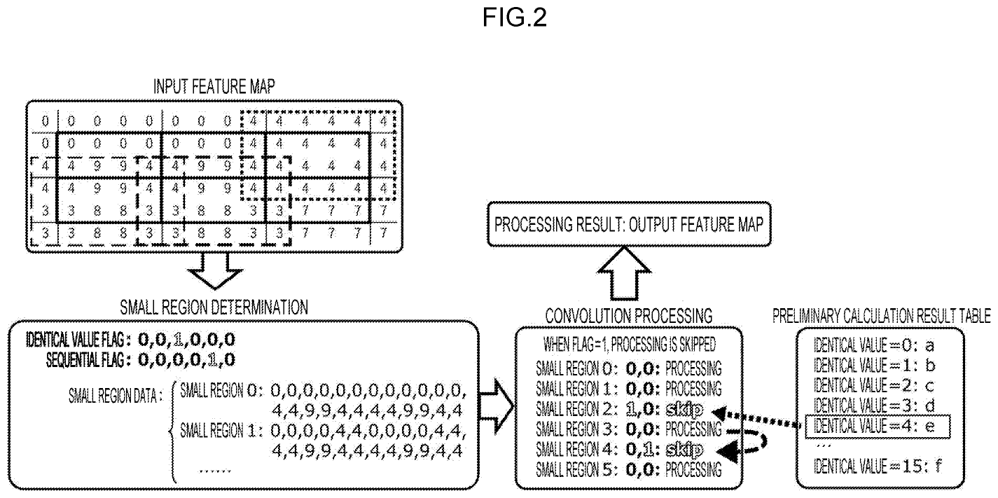

Furthermore, as illustrated in FIG. 2, an identical value flag indicating a determination result for each small region of whether the small region is a small region including identical values, a sequential flag indicating a determination result for each small region of whether the small region is a small region that is sequentially the same, and small region data that is data of each small region of the input feature map are input to an arithmetic circuit that performs convolution processing.

In the arithmetic circuit, in a case where the small region to be processed is a small region including identical values or a small region that is sequentially the same, the processing is skipped and convolution processing is not performed. In a case where the small region is a small region that is sequentially the same, the processing result is the same as that of the small region that has been previously processed. Therefore, it is only necessary to continuously output the processing result of the small region that has been previously processed, and the processing speed is increased. FIG. 2 illustrates an example in which processing is skipped for small region 4 because features in the small region 3 and features in small region 4 are the same.

Furthermore, the processing result is limited for a small region including identical values. In a case where the value indicating the feature is 4 bits, there are 16 patterns of processing results, and in a case where the value indicating the feature is 8 bits, there are 256 patterns of processing results. Processing results of all patterns are calculated in advance and a preliminary calculation result table is stored in the RAM, and the preliminary calculation result table is read from the RAM to an internal memory of the arithmetic circuit for each processing of each layer. As a result, since it is possible to obtain the processing result only by referring to the internal memory without performing the convolution processing on a small region including identical values, the processing speed is increased. FIG. 2 illustrates an example in which, since small region 2 is a small region including identical values, processing is skipped for small region 2, and the processing result in a case where all features are 4 stored in the preliminary calculation result table is referred to and output.

Furthermore, as illustrated in FIG. 2, an output feature map that is a result of convolution processing by the arithmetic circuit is written to a RAM or the like. The written output feature map is used as an input feature map in subsequent layers, and the above-described determination processing and convolution processing using the processing skip are repeated again.

Here, the size of small regions to be processed at a time is proportional to the scale of the arithmetic circuit. In addition, the throughput of inference processing is improved as the size of small regions to be processed at a time is increased. However, in a case where an attempt is made to increase the size of small regions in order to increase the throughput, there is a tendency that less small regions of the input feature map are small regions including identical values or small regions that are sequentially the same. For this reason, it is not possible to expect in many cases a sufficient calculation speedup as a throughput by an increase in scale of the arithmetic circuit.

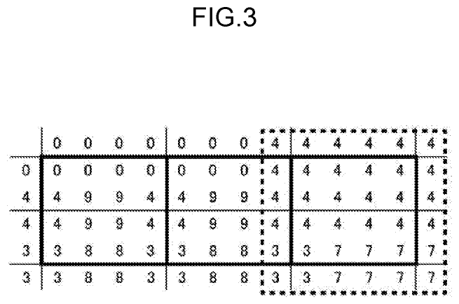

For example, as illustrated in FIG. 3, in a case where the size of the small region of the output feature map is set to 4×4 instead of 4×2 (in a case where the size of the small region of the input feature map is 6×6 instead of 6×4), the feature map is divided into three small regions, but the values inside are not identical in any of the small regions. Furthermore, none of the small regions is a small region that is sequentially the same. Thus, the processing is not skipped, and three times of convolution processing are required.

In a case where the size of the small region of the output feature map is 4×2, since one of the six small regions is a small region including identical values and one of the six small regions is a small region that is sequentially the same (see FIG. 2 described above), the processing is skipped two times, and only four times of convolution processing are required.

In order to change the size of the small region of the output feature map from 4×2 to 4×4, it is necessary to double the scale of the arithmetic circuit as hardware, but on the other hand, since the processing is not skipped, the actual throughput increases only 4/3 times. The throughput per arithmetic circuit drops to (4/3)/2=2/3 times. As described above, a skip rate tends to decrease as the size of the small region is improved, and thus the effect of increasing the speed of the arithmetic circuit by processing skipping may be reduced.

Thus, in the present embodiment, in convolution processing using a neural network, the effect of processing skipping is enhanced in a range in which the influence on the processing accuracy is small, and thus the calculation speed is increased.

Specifically, in a case of a small region in which all the values inside the small region are not identical or all the values inside the small region are not successively the same, skipping of the convolution processing is applied in a case where the influence on the processing accuracy is small, so that the calculation speed is increased by processing skipping even in a case where the size of the small region is large or a bit depth is large.

As a case where the influence on the processing accuracy is small, skipping is performed in a case where a difference from the features in a small region including identical values or the features in a small region that is sequentially the same is equal to or less than a threshold. More specifically, in (1) a case where the difference in each pixel of the small region is equal to or less than the threshold, or in (2) a case where the number of pixels that are different in the features in the small region is equal to or less than the threshold, processing skipping is applied.

“(1) A case where the difference in each pixel of the small region is equal to or less than the threshold” will be described below in detail.

The processing is skipped in a case where the features in the small region can be regarded as a small region including identical values or a small region that is sequentially the same when the accuracy is reduced.

In small region determination, it is determined, with mismatch in several lower bits being treated as permissible, whether the small region is a small region including identical values and whether the small region is a small region that is sequentially the same. At this time, for the features in the small region to be processed, the lower bits are masked, and then it is determined whether all the features have identical values, and it is determined whether the small region is a small region that is sequentially the same.

At this time, a bit number α1 of the lower bits to be masked at the time of determining whether the small region is a small region including identical values is set as a setting parameter.

At this time, a bit number α2 of the lower bits to be masked at the time of determining whether the small region is a small region that is sequentially the same is set as a setting parameter.

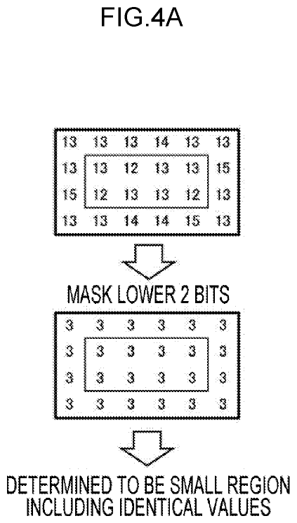

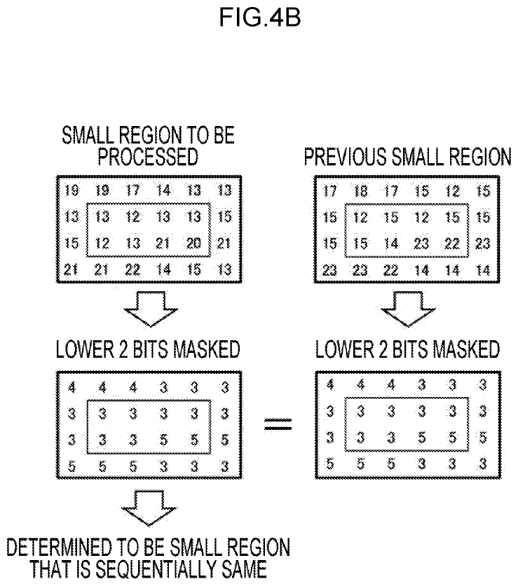

For example, as illustrated in FIG. 4A, α=2 is set, and in order to ignore lower 2 bits, the lower 2 bits “01” in a binary number “1101” (that is, a 10 decimal number “13”) are masked, and the binary number “1101” is considered as a binary number “11” (that is, a 10 decimal number “3”). This is equivalent to “>>α”, that is, rightward shifting by α bits. It is also equivalent to taking the value of the quotient of division by 2^{α} (13% (2²)=13% 4=3).

FIG. 4A illustrates an example in which, in a case where the difference in each pixel of the small region is equal to or less than the threshold, the small region is determined to be a small region including identical values. In this example, α1=2 is set, the kernel size is 3×3, and the size of output small regions is 4×2 (input: 6×4). In a case where the determination processing is performed with α1=0, that is, with the values inside the small region as they are, all the 6×4 =24 values are not identical values, and it is therefore not determined that the small region is a small region including identical values. On the other hand, in a case of α1=2, since the lower 2 bits are masked, all the 24 values become 3, and it is determined that the small region is a small region including identical values, and the processing is skipped.

FIG. 4B illustrates an example in which it is determined that the small regions is a small region that is sequentially the same in a case where the difference in each pixel of the small region is equal to or less than the threshold. In this example, α1=2 is set, the kernel size is 3×3, and the size of output small regions is 4×2 (size of input small regions is 6×4). In a case where the determination processing is performed with α2=0, that is, with the values inside the small region as they are, the 6×4=24 values in the small region to be processed do not coincide at all with those in the previous small region, and it is not determined that the small region is a small region that is sequentially the same. On the other hand, in a case of α2=2, since the lower 2 bits are masked, all the 24 values in the small region to be processed coincide with those in the previous small region, and it is determined that the small region is a small region that is sequentially the same and processing skipping is applied.

“(2) A case where the number of pixels of features different from those in the small region is equal to or less than the threshold” will be described below in detail. The processing is skipped in a case where the features in the small region can be regarded as a small region including identical values or a small region that is sequentially the same except for some of the pixels.

In small region determination, it is determined, with mismatch in several features in the small region being treated as permissible, whether the small region is a small region including identical values or whether the small region is a small region that is sequentially the same.

At this time, for the features in the small region, the number of pixels that are not identical in value and the number of pixels that do not coincide with those in the previous small region are counted. In a case where the number of counts is equal to or less than a threshold, it is determined that the small region is a small region including identical values or a small region that is sequentially the same, and the processing is skipped.

As setting parameters, a pixel number β1 of pixels with values that are not identical, the pixel number being permissible at the time of determining whether the small region is a small region including identical values, and a pixel number β2 of pixels that are not the same as those in the previous small region, the pixel number being permissible at the time of determining whether the small region is a small region that is sequentially the same, are set.

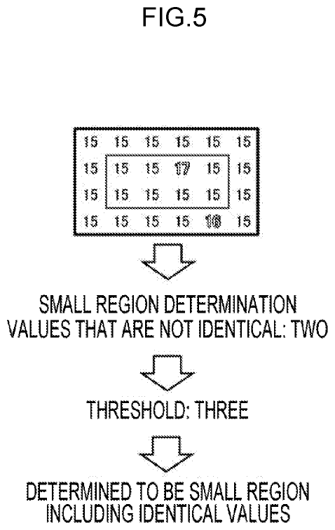

FIG. 5 illustrates an example in which, in a case where the number of pixels of features different from those in the small region is equal to or less than the threshold, it is determined that the small region is a small region including identical values. In this example, β1=3 is set, the kernel size is 3×3, and the size of output small regions is 4×2 (size of input small regions is 6×4).

In a case of β1=0, that is, in a case where not a single value that is not identical is permitted to exist, all the 6×4=24 values are not identical values, and it is therefore not determined that the small region is a small region including identical values. On the other hand, in a case of β1=3, up to three pixels that are not identical in value are permissible. In FIG. 5, since a total of two values “17” and “16” are not identical, 2≤β1 holds, and it is determined that the small region is a small region including identical values, and the processing is skipped.

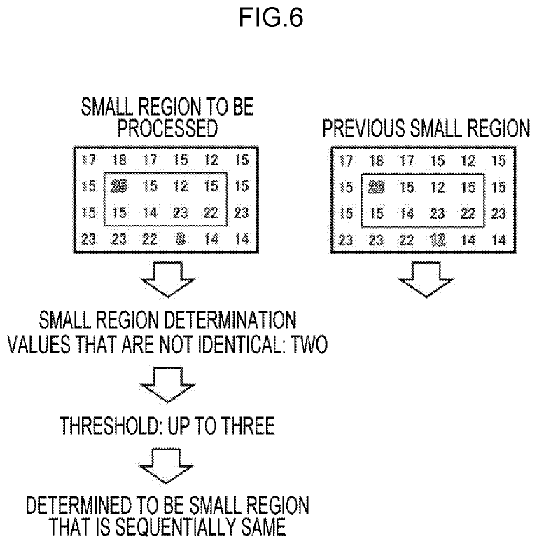

FIG. 6 illustrates an example in which, in a case where the number of pixels of features different from those in the small region is equal to or less than the threshold, it is determined that the small region is a small region that is sequentially the same. In this example, β1=3 is set, the kernel size is 3×3, and the size of output small regions is 4×2 (size of input small regions is 6×4).

In a case of β2=0, that is, in a case where not a single value in the small region to be processed that does not coincide with that in the previous small region is permitted to exist, not all the 6×4=24 values in the small region coincide with those in the previous small region, and thus, it is not determined that the small region is a small region that is sequentially the same.

On the other hand, in a case of β2=3, up to three pixels that do not coincide are permissible. In FIG. 6, since there are two pairs {“25” and “28”} and {“8” and “12”} in total that do not coincide with each other between the small region to be processed and the previous small region and two is smaller than β2, it is determined that the small region is a small region that is sequentially the same, and the processing is skipped.

The bit numbers α1 and α2 and the pixel numbers β1 and β2, which correspond to thresholds, are determined in advance such that processing using a neural network is performed with predetermined accuracy. Note that the values of the bit numbers α1 and α2 and the pixel numbers β1 and β2 may be dynamically set during the inference processing.

### First Embodiment

### <Configuration of Image Processing Device According to First Embodiment>

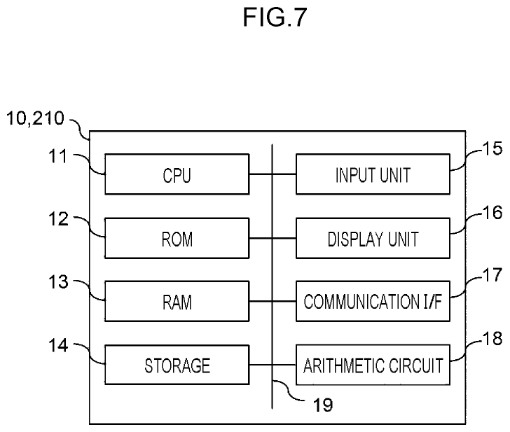

FIG. 7 is a block diagram illustrating a hardware configuration of an image processing device 10 according to a first embodiment.

As illustrated in FIG. 7, the image processing device 10 includes a central processing unit (CPU) 11, a read only memory (ROM) 12, a RAM 13, a storage 14, an input unit 15, a display unit 16, a communication interface (I/F) 17, and an arithmetic circuit 18. The components are communicatively connected to each other via a bus 19.

The CPU 11 is a central processing unit that executes various programs and controls each unit. That is, the CPU 11 reads a program from the ROM 12 or the storage 14, and executes the program using the RAM 13 as a working area. The CPU 11 performs control of each of the components described above and various types of arithmetic processing in accordance with a program stored in the ROM 12 or the storage 14. In the present embodiment, the ROM 12 or the storage 14 stores a learning processing program for performing learning processing of a neural network and an image processing program for performing image processing using the neural network. The learning processing program and the image processing program may be one program or a program group including a plurality of programs or modules.

The ROM 12 stores various programs and various types of data. The RAM 13, as a working area, temporarily stores programs or data. The storage 14 includes a hard disk drive (HDD) or a solid state drive (SSD) and stores various programs including an operating system and various types of data.

The input unit 15 includes a pointing device such as a mouse and a keyboard and is used to perform various inputs.

The input unit 15 receives learning data for learning the neural network as an input. For example, the input unit 15 receives, as an input, learning data including a target image to be processed and a processing result of the target image obtained in advance.

Furthermore, the input unit 15 receives a target image to be processed as an input.

The display unit 16 is, for example, a liquid crystal display, and displays various types of information including a processing result. The display unit 16 may function as the input unit 15 by adopting a touchscreen system.

The communication interface 17 is an interface for communicating with another device, and for example, standards such as Ethernet (registered trademark), FDDI, and Wi-Fi (registered trademark) are used.

The arithmetic circuit 18 executes convolution processing in a convolutional layer of the neural network. Specifically, the arithmetic circuit 18 receives a small region of the input feature map and a kernel, and outputs a small region of an output feature map, which is a result of convolution processing of each point in the small region.

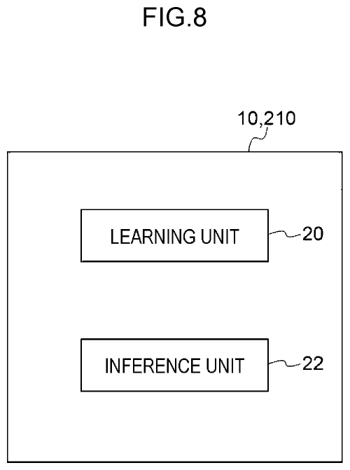

Next, a functional configuration of the image processing device 10 will be described. FIG. 8 is a block diagram illustrating an example of a functional configuration of the image processing device 10.

The image processing device 10 functionally includes a learning unit 20 and an inference unit 22 as illustrated in FIG. 8.

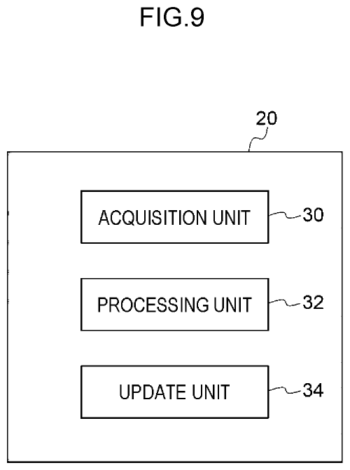

As illustrated in FIG. 9, the learning unit 20 includes an acquisition unit 30, a processing unit 32, and an update unit 34.

The acquisition unit 30 acquires an input target image and a processing result in learning data.

The processing unit 32 processes the target image using a neural network including convolution processing. When performing the convolution processing, the processing unit 32 performs the convolution processing for each small region obtained by dividing the input feature map to be an input of the convolution processing. The convolution processing for each small region is executed using the arithmetic circuit 18. At this time, the small region data of the input feature map and the kernel are input to the arithmetic circuit 18, and the output feature map representing the result of the convolution processing for each small region is output from the arithmetic circuit 18.

Here, the input feature map is divided into small regions as illustrated in FIG. 1 described above. In FIG. 1 described above, a region corresponding to a small region of the output feature map is indicated with a thick line frame, and a small region of the input feature map is a region including a small region of the corresponding output feature map and overlapping regions overlapping an adjacent small region. As described above, a small region obtained by dividing the input feature map includes an overlapping region overlapping adjacent small regions and having an overlapping region corresponding to the kernel size of the convolution processing. Note that division into small regions is determined at design time. For example, the division may be determined by a balance between hardware restriction (size or electric power) and desired throughput (e.g., xxfps). In a case where the kernel size is 3×3, the small region of the input feature map is 10×6, and the small region of the output feature map is 8×4, throughput capable of simultaneously outputting 32 points is obtained. At this time, 288 (=(3×3)×8×4) product-sum operation circuits are required. Furthermore, in a case where the small region of the input feature map is 6×4 and the small region of the output feature map is 4×2, throughput at which only eight points are simultaneously output is obtained. At this time, 72 (=(3×3)×4×2) product-sum operation circuits are required. Furthermore, in a case where the product-sum operation is achieved by hardware, division into small regions is determined at design time, and thus the division into small regions does not change depending on the layer.

When performing the convolution processing for each small region, in a case where all the features constituting the small region correspond to a small region including identical values, the arithmetic circuit 18 does not perform convolution processing for the small region, and outputs, as a processing result for the small region, a predetermined result of processing performed for a case where all the features constituting the small region have the identical values.

Specifically, the processing unit 32 determines, for each small region, whether all the features constituting the small region correspond to a small region including identical values. In a case where it is determined that all the features constituting the small region correspond to a small region including identical values, the arithmetic circuit 18 does not perform convolution processing for the small region, and outputs, as a processing result for the small region, a result of processing performed for a case where all the features constituting the small region have the identical values stored in the preliminary calculation result table.

More specifically, in a case where the difference from features in a small region including identical values is equal to or less than a threshold for each small region, the processing unit 32 determines that all the features constituting the small region correspond to the small region including identical values. For example, in a case where bits other than a predetermined bit number α1 of lower bits representing the features in the small region to be processed are the same, it is determined that all the features constituting the small region correspond to a small region including identical values.

Furthermore, in a case where the number of pixels of features different from those in a small region including identical values is equal to or less than the threshold, for each small region, the processing unit 32 determines that all the features constituting the small region correspond to the small region including identical values. For example, in a case where a comparison is made with a small region including identical values, the number of pixels that are different in the features is counted, and the counted number of pixels is equal to or less than a threshold β1, it is determined that all the features constituting the small region correspond to a small region including identical values.

Furthermore, when performing the convolution processing for each small region, in a case where features constituting the small region correspond to features in a previously processed small region, the arithmetic circuit 18 does not perform convolution processing for the small region, and outputs a result of processing on the previously processed small region as a processing result for the small region.

Specifically, the processing unit 32 determines, for each small region, whether the features constituting the small region correspond to the features in the previously processed small region. In a case where it is determined that the features constituting the small region correspond to the features in the previously processed small region, the arithmetic circuit 18 does not perform convolution processing for the small region, and outputs a result of processing on the previously processed small region as a processing result for the small region.

More specifically, in a case where the difference from the features in the previously processed small region is equal to or less than a threshold for each small region, the processing unit 32 determines that the features constituting the small region correspond to the features in the previously processed small region. For example, in a case where bits other than a predetermined bit number α2 of lower bits representing the features in the previously processed small region are the same as bits other than a predetermined bit number α2 of lower bits representing the features in the small region, it is determined that the features constituting the small region correspond to the features in the previously processed small region.

Furthermore, in a case where the number of pixels of features different from those in the previously processed small region is equal to or less than the threshold, for each small region, the processing unit 32 determines that the features constituting the small region correspond to the features in the previously processed small region. For example, in a case where a comparison is made with the previously processed small region, the number of pixels that are different in the features is counted, and the counted number of pixels is equal to or less than a threshold β2, it is determined that the features constituting the small region correspond to the features in the previously processed small region.

The update unit 34 updates the parameters of the neural network so that the result of processing on the target image using the neural network coincides with the processing result obtained in advance. Furthermore, the update unit 34 updates the preliminary calculation result table of each convolutional layer on the basis of the updated parameters of the neural network.

Processing of each of the processing unit 32 and the update unit 34 is repeatedly performed until a predetermined repetition end condition is satisfied. As a result, the neural network is learned.

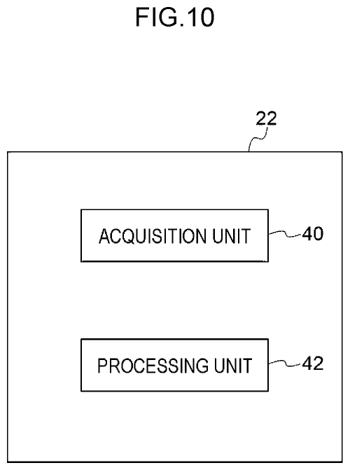

As illustrated in FIG. 10, the inference unit 22 includes an acquisition unit 40 and a processing unit 42.

The acquisition unit 40 acquires an input target image to be processed.

The processing unit 42 processes the target image using a neural network including convolution processing. When performing the convolution processing, the processing unit 42 performs the convolution processing for each small region obtained by dividing the input feature map to be an input of the convolution processing. The convolution processing for each small region is executed using the arithmetic circuit 18. At this time, the small region data of the input feature map and the kernel are input to the arithmetic circuit 18, and the output feature map representing the result of the convolution processing for each small region is output from the arithmetic circuit 18.

Similarly to the processing unit 32, the processing unit 42 determines, for each small region, whether all the features constituting the small region correspond to a small region including identical values. In a case where it is determined that all the features constituting the small region correspond to a small region including identical values, the arithmetic circuit 18 does not perform convolution processing for the small region, and outputs, as a processing result for the small region, a result of processing performed for a case where all the features constituting the small region have the identical values, the result being stored in the preliminary calculation result table.

Furthermore, similarly to the processing unit 32, the processing unit 42 determines whether the features constituting the small region correspond to the features in the previously processed small region. In a case where it is determined that the features constituting the small region correspond to the features in the previously processed small region, the arithmetic circuit 18 does not perform convolution processing for the small region, and outputs a result of processing on the previously processed small region as a processing result for the small region.

A result of processing the target image using the neural network is displayed by the display unit 16.

### <Operation of Image Processing Device According to First Embodiment>

Next, an operation of the image processing device 10 according to the first embodiment will be described.

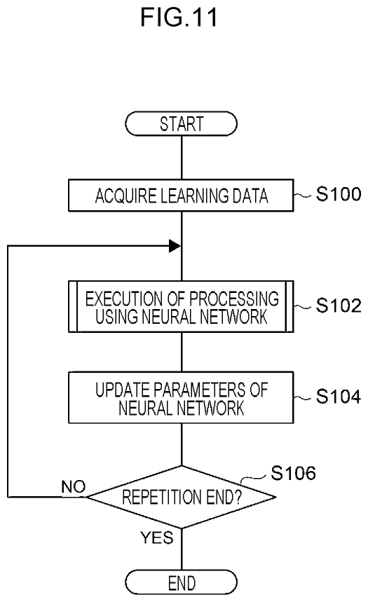

FIG. 11 is a flowchart illustrating a flow of learning processing by the image processing device 10. Learning processing is performed by the CPU 11 reading a learning processing program from the ROM 12 or the storage 14, loading the learning processing program in the RAM 13, and executing the learning processing program. Furthermore, learning data is input to the image processing device 10.

In step S100, the CPU 11, as the acquisition unit 30, acquires a target image to be processed and a processing result in the input learning data.

In step S102, the CPU 11, as the processing unit 32, processes the target image in the learning data using a neural network including convolution processing.

In step S104, the CPU 11, as the update unit 34, updates the parameters of the neural network so that the result of processing on the target image in the learning data using the neural network coincides with the processing result obtained in advance, and updates the preliminary calculation result table.

In step S106, the CPU 11 determines whether a predetermined repetition end condition is satisfied. If the repetition end condition is not satisfied, the processing returns to step S102 described above, and processing of each of the processing unit 32 and the update unit 34 is repeatedly performed. As a result, the neural network is learned.

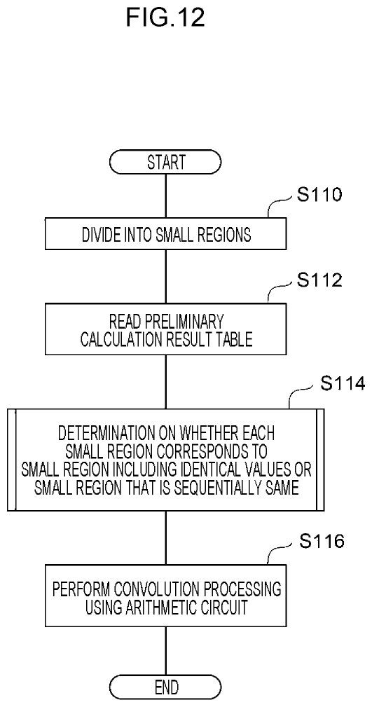

In step S102 described above, arithmetic processing of each layer of the neural network is performed. Here, the arithmetic processing in a convolutional layer is achieved by a processing routine illustrated in FIG. 12.

In step S110, the CPU 11, as the processing unit 32, divides the input feature map to be an input of the convolutional layer into small regions.

In step S112, the CPU 11, as the processing unit 32, reads the preliminary calculation result table of the convolutional layer from the RAM 13.

In step S114, the CPU 11, as the processing unit 32, sequentially sets the divided small regions as processing targets, and determines whether the features constituting the small region to be processed correspond to a small region including identical values, or whether the features correspond to features in the previously processed small region.

Specifically, in a case where the difference from the features in the small region including identical values is equal to or less than a threshold, the CPU 11 determines that the features constituting the small region to be processed correspond to the small region including identical values.

In a case where the number of pixels of features different from those in a small region including identical values is equal to or less than the threshold, the CPU 11 determines that the features constituting the small region to be processed correspond to the small region including identical values.

In a case where the difference from the features in the previously processed small region is equal to or less than the threshold, the CPU 11 determines that the features constituting the small region to be processed correspond to the features in the previously processed small region.

In a case where the number of pixels of features different from those in the previously processed small region is equal to or less than the threshold, the CPU 11 determines that the features constituting the small region to be processed correspond to the features in the previously processed small region.

In step S116, the CPU 11, as the processing unit 32, outputs, to the arithmetic circuit 18, each piece of small region data of the input feature map, the preliminary calculation result table, and an identical value flag and a sequential flag indicating the determination result in step S114 described above. Then, the arithmetic circuit 18 performs convolution processing for each small region. At this time, in a case where the small region to be processed does not correspond to a small region including identical values and does not correspond to a small region that is sequentially the same, the arithmetic circuit 18 performs convolution processing for the small region to be processed. In a case where the small region to be processed corresponds to a small region including identical values, the arithmetic circuit 18 does not perform convolution processing for the small region to be processed, and outputs, as a processing result for the small region to be processed, a result of processing performed for a case where the features constituting the small region have the identical values stored in the preliminary calculation result table.

In a case where the small region to be processed corresponds to a small region that is sequentially the same, the arithmetic circuit 18 does not perform convolution processing for the small region to be processed, and outputs a result of processing on the previously processed small region as a processing result for the small region to be processed.

Then, the processing routine is ended, and an output feature map including a processing result for each small region is output as an input feature map of the next layer.

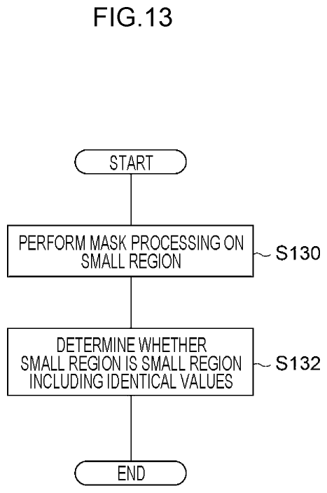

In step S114 described above, the divided small regions are sequentially set as processing targets, and it is determined whether the features constituting the small region to be processed correspond to a small region including identical values, or whether the features correspond to features in the previously processed small region. Here, in a case where the difference in each pixel of the small region is equal to or less than the threshold, processing of determining that the small region corresponds to a small region including identical values is performed by a processing routine illustrated in FIG. 13.

In step S130, the CPU 11 performs, as the processing unit 32, mask processing of masking the predetermined bit number α1 of lower bits for the features in the small region to be processed.

In step S132, the CPU 11, as the processing unit 32, determines whether the features constituting the small region to be processed correspond to a small region including identical values on the basis of whether all the features in the small region to be processed after the mask processing in step S130 described above have identical values.

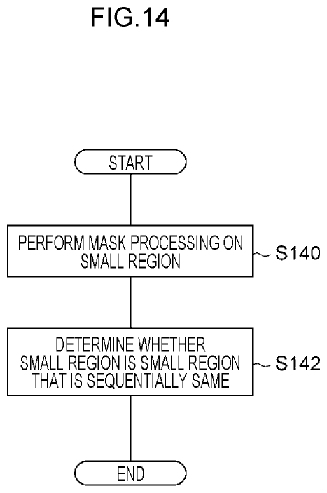

Furthermore, in a case where the difference in each pixel of the small region is equal to or less than the threshold, processing of determining that the small region corresponds to a small region that is sequentially the same is performed by a processing routine illustrated in FIG. 14.

In step S140, the CPU 11 performs, as the processing unit 32, mask processing of masking the predetermined bit number α2 of lower bits for the features in the small region to be processed.

In step S142, the CPU 11, as the processing unit 32, determines whether the features constituting the small region to be processed correspond to the previously processed small region, on the basis of whether the features in the small region to be processed after the mask processing in step S140 described above are the same as the features in the previously processed small region after the mask processing.

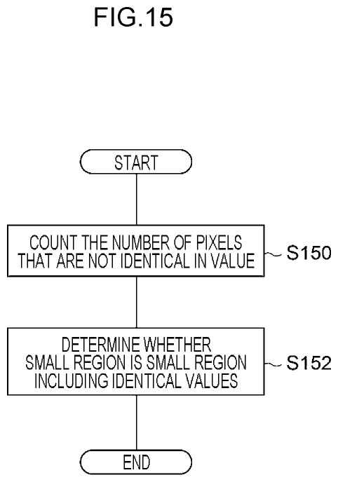

Furthermore, in a case where the number of pixels of features different from those in the small region is equal to or less than the threshold, processing of determining that the features correspond to a small region including identical values is performed by a processing routine illustrated in FIG. 15.

In step S150, the CPU 11, as the processing unit 32, compares the small region to be processed with a small region including identical values, and counts the number of pixels that are different in the features.

In step S152, the CPU 11, as the processing unit 32, determines whether the features constituting the small region to be processed correspond to the small region including identical values on the basis of whether the number of pixels counted in step S150 described above is equal to or less than the threshold β1.

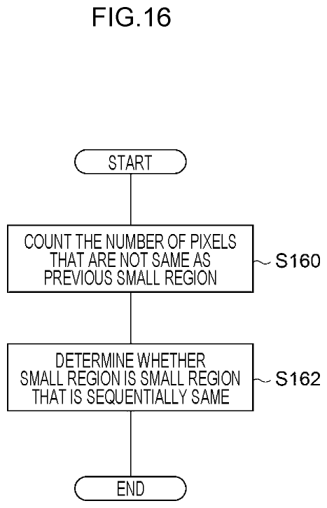

Furthermore, in a case where the number of pixels of features different from those in the small region is equal to or less than the threshold, processing of determining that the small region corresponds to a small region that is sequentially the same is performed by a processing routine illustrated in FIG. 16.

In step S160, the CPU 11, as the processing unit 32, compares the small region to be processed with the previously processed small region, and counts the number of pixels that are different in the features.

In step S162, the CPU 11, as the processing unit 32, determines whether the features constituting the small region to be processed correspond to the previously processed small region, on the basis of whether the number of pixels counted in step S160 described above is equal to or less than the threshold β2.

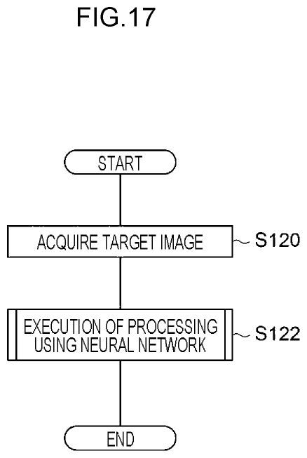

FIG. 17 is a flowchart illustrating a flow of image processing by the image processing device 10. The image processing is performed by the CPU 11 reading the image processing program from the ROM 12 or the storage 14, developing the image processing program in the RAM 13, and executing the image processing program. Furthermore, a target image is input to the image processing device 10.

In step S120, the CPU 11, as the acquisition unit 40, acquires the input target image.

In step S122, the CPU 11, as the processing unit 42, processes the target image using the neural network learned by the above-described learning processing. Then, a result of processing the target image using the neural network is displayed by the display unit 16.

In step S122 described above, arithmetic processing of each layer of the neural network is performed. Here, the arithmetic processing in a convolutional layer is achieved by the processing routine illustrated in FIG. 12 described above.

As described above, when performing convolution processing for each small region of the input feature map, the image processing device according to the first embodiment does not perform convolution processing for the small region in a case where the features constituting the small region correspond to a small region including identical values or correspond to the features in the previously processed small region, and outputs, as a processing result for the small region, the result of processing on the small region including identical values determined in advance or the result of the previous processing. As a result, processing using a neural network including convolution processing can be speeded up.

In a case where the size of small regions obtained by dividing the input feature map is increased in order to improve throughput, or in a case where the bit depth representing the input feature map is increased in order to improve CNN calculation accuracy, in conventional methods, there are less cases where all the values inside the small region are 0, and the calculation cannot be speeded up in many cases. For example, in a case where features of the input feature map are represented by 4-bit data, the values inside the small region are all zero, whereas in a case where the features in the input feature map are represented by 6-bit data, the values inside the small region are not all zero. On the other hand, in the present embodiment, in a small region corresponding to a small region including identical values or a small region that is sequentially the same, a sufficient calculation speedup can be expected as compared with the conventional methods.

In addition, the bit numbers α1 and α2 to be masked and the upper limits β1 and β2 of the number of pixels having different characteristics are set as parameters. The larger the parameter value, the higher the skip rate and the higher the speed, and the smaller the parameter value, the less influence on the CNN calculation accuracy.

It is possible to determine a value suitable for the neural network by a preliminary experiment or the like. By the preliminary experiment, it is possible to determine values for α1, α2, β1, and β2, the values resulting in the highest skip performance in many cases among values that allow for CNN calculation accuracy of a certain level or higher.

Alternatively, it is also possible to feed back changes in the CNN calculation accuracy and adaptively change the parameter values within a range in which the influence on the CNN calculation accuracy is small. For example, in a case where a threshold of the CNN calculation accuracy has been set and the CNN calculation accuracy falls below the threshold during inference processing, it is possible to lower α1, α2, β1, and β2 by one level, thereby adaptively improving the CNN calculation accuracy.

With the processing as described above, it is possible to significantly improve the skip rate while suppressing the influence on the CNN calculation accuracy to a certain value or less, and it is possible to expect speedup of the entire CNN arithmetic processing.

### Second Embodiment

Next, a second embodiment will be described. Note that the configuration is similar to that in the first embodiment, and thus the same reference numerals are given and the description thereof is omitted.

The second embodiment is different from the first embodiment in that, in small region determination, after mask processing, the number of pixels that are different in the features in the small region is counted, and whether the counted number of pixels corresponds to a small region including identical values or a small region that is sequentially the same is determined on the basis of whether the counted number of pixels is equal to or less than a threshold.

### <Overview of Second Embodiment>

In the second embodiment, both (1) a case where the difference in each pixel of the small region is equal to or less than the threshold and (2) a case where the number of pixels that are different in the features in the small region is equal to or less than the threshold are simultaneously considered. Specifically, each of the setting parameters α1, α2, β1, and β2 is set, and masking of lower bits and counting of the number of pixels that are different in the features in the small region are simultaneously performed.

As a result, the processing is skipped on the condition that any number of pixels is permissible in a case where the difference in each pixel is equal to or less than a threshold, and that a certain number β1 or β2 or less of pixels having a difference in each pixel equal to or more than the threshold is permissible.

### <Configuration of Image Processing Device According to Second Embodiment>

A processing unit 32 determines, for each small region, whether all the features constituting the small region correspond to a small region including identical values. In a case where it is determined that all the features constituting the small region correspond to a small region including identical values, an arithmetic circuit 18 does not perform convolution processing for the small region, and outputs, as a processing result for the small region, a result of processing performed for a case where all the features constituting the small region have the identical values stored in the preliminary calculation result table.

Specifically, in a case where, for each small region, the difference from features in a small region including identical values is equal to or less than the threshold, it is regarded that the features are the same, and then, in a case where the number of pixels of features different from those in the small region including identical values is equal to or less than the threshold, the processing unit 32 determines that all the features constituting the small region correspond to the small region including identical values. For example, in a case where bits other than a predetermined bit number α1 of lower bits representing features in a small region to be processed are the same, it is regarded that the features are the same, and then, in a case where a comparison is made with a small region including identical values, the number of pixels that are different in the features is counted, and the counted number of pixels is equal to or less than a threshold β1, it is determined that all the features constituting the small region correspond to the small region including identical values.

Furthermore, the processing unit 32 determines, for each small region, whether the features constituting the small region correspond to the features in the previously processed small region. In a case where it is determined that the features constituting the small region correspond to the features in the previously processed small region, the arithmetic circuit 18 does not perform convolution processing for the small region, and outputs a result of processing on the previously processed small region as a processing result for the small region.

Specifically, in a case where a difference from the features in the previously processed small region is equal to or less than the threshold, for each small region, it is regarded that the features are the same, and then, in a case where the number of pixels of features different from those in the previously processed small region is equal to or less than the threshold, the processing unit 32 determines that the features constituting the small region correspond to the features in the previously processed small region.

For example, in a case where bits other than a predetermined bit number α2 of lower bits representing the features in the small region to be processed are the same, it is regarded that the features are the same, and then, in a case where a comparison is made with the previously processed small region, the number of pixels that are different in the features is counted, and the counted number of pixels is equal to or less than a threshold β2, it is determined that all the features constituting the small region correspond to the features in the previously processed small region.

### <Operation of Image Processing Device According to Second Embodiment>

The arithmetic processing in a convolutional layer is achieved by the processing routine illustrated in FIG. 12 described above. Here, in step S114, a CPU 11, as the processing unit 32, sequentially sets the divided small regions as processing targets, and determines whether the features constituting the small region to be processed correspond to a small region including identical values, or whether the features correspond to features in the previously processed small region.

Specifically, in a case where the difference from features in a small region including identical values is equal to or less than the threshold, it is regarded that the features are the same, and then, in a case where the number of pixels of features different from those in the small region including identical values is equal to or less than the threshold, the CPU 11 determines that the features constituting the small region to be processed correspond to the small region including identical values.

In a case where the difference from the features in the previously processed small region is equal to or less than the threshold, it is regarded that the features are the same, and then, in a case where the number of pixels of features different from those in the previously processed small region is equal to or less than the threshold, the CPU 11 determines that the features constituting the small region to be processed correspond to the features in the previously processed small region.

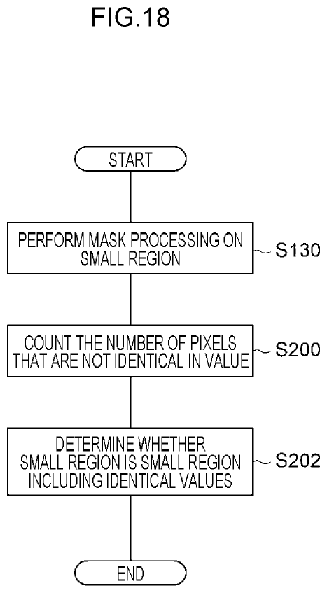

In step S114 described above, the divided small regions are sequentially set as processing targets, and it is determined whether the features constituting the small region to be processed correspond to a small region including identical values, or whether the features correspond to features in the previously processed small region. Here, in a case where the difference in each pixel of the small region is equal to or less than the threshold, it is regarded that the features are the same, and then, in a case where the number of pixels of features different from those in the small region is equal to or less than the threshold, processing of determining that the small region corresponds to a small region including identical values is performed by a processing routine illustrated in FIG. 18.

In step S130, the CPU 11 performs, as the processing unit 32, mask processing of masking the predetermined bit number α1 of lower bits for the features in the small region to be processed.

In step S200, the CPU 11, as the processing unit 32, compares the small region to be processed after the mask processing with a small region including identical values, and counts the number of pixels that are different in the features.

In step S202, the CPU 11, as the processing unit 32, determines whether the features constituting the small region to be processed correspond to the small region including identical values on the basis of whether the number of pixels counted in step S200 described above is equal to or less than the threshold β1.

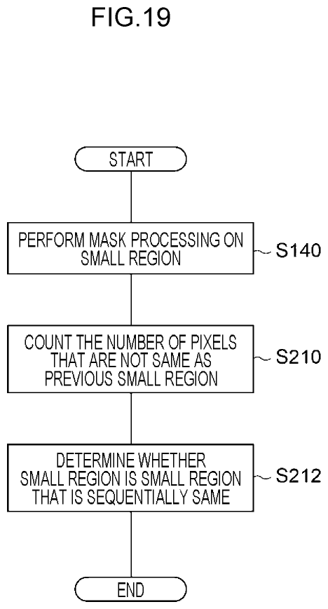

Furthermore, in a case where the difference in each pixel of the small region is equal to or less than the threshold, it is regarded that the features are the same, and then, in a case where the number of pixels of features different from those in the small region is equal to or less than the threshold, processing of determining that the small region corresponds to a small region that is sequentially the same is performed by a processing routine illustrated in FIG. 19.

In step S140, the CPU 11 performs, as the processing unit 32, mask processing of masking the predetermined bit number α2 of lower bits for the features in the small region to be processed.

In step S210, the CPU 11, as the processing unit 32, compares the small region to be processed after the mask processing with the previously processed small region after the mask processing, and counts the number of pixels that are different in the features.

In step S212, the CPU 11, as the processing unit 32, determines whether the features constituting the small region to be processed correspond to the previously processed small region, on the basis of whether the number of pixels counted in step S210 described above is equal to or less than the threshold β2.

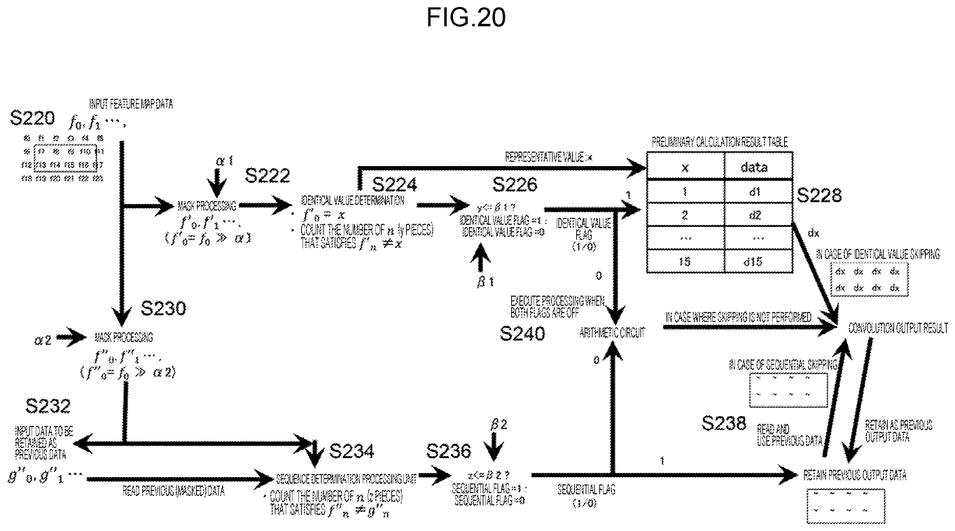

Next, an example of arithmetic processing in a convolutional layer will be described with reference to FIG. 20.

First, one small region is given as an input feature map (S220). FIG. 20 illustrates a case of 8-bit accuracy, a kernel size of 3×3, and a small region size of 4×2 to be output. In this case, the size of the small region to be processed is 6×4. The 24 features in the small region are expressed as fₜ (t: 0 to 23).

Then, mask processing for determining whether the small region is a small region including identical values is performed (S222). A parameter α1 is given, and f′ₜ=fₜ>>α1 is used to calculate a feature f′ₜ in the small region after the mask processing.

In addition, counting processing for determining whether the small region is a small region including identical values is performed (S224). For the small region after the mask processing, a first value f′₀ is set to x, and the number of f′_{nS} that are not identical in value to x is counted and denoted by y.

In a case where y≤β1 holds and bits other than a predetermined bit number α1 of lower bits representing the features in the small region to be processed are the same, it is regarded that the features are the same, and then, a comparison is made with a small region including identical values and it is determined that the number of pixels that are different in the features is equal to or less than the threshold β1, and it is determined that the small region is a small region including identical values (S226). An identical value flag is set to 1.

In a case where the identical value flag is 1, the processing is skipped (S228). x (=f′₀) is a representative value of the small region, and a result of convolution processing corresponding to×stored in the preliminary calculation result table may be used as it is as output data.

For example, in a case of a1=4, since f′ₜ corresponds to 8−4=4 bits, f′ₜ takes only 16-level values. Results of convolution processing indicating outputs in individual cases are stored in advance as a preliminary calculation result table.

In a case where a small region including identical values is input, all the values inside are identical also in the result of convolution processing, and it is therefore necessary to store only one value for each of 16-level input values. In this case, it is only necessary to fill all eight values in the size of 4×2 of the result of the convolution processing with dx, the dx being output data for the representative value x of the input, to obtain the result of the convolution processing, and it is possible to acquire the operation result only by reading the data, without an actual product-sum operation.

Furthermore, mask processing for determining whether the small region is a small region that is sequentially the same is performed (S230). A parameter α2 is given, and as f″ₜ=fₜ>>α2 is used to calculate a feature f″ₜ in the small region after the mask processing.

Furthermore, the values after the mask processing (6×4=24 values) are stored so as to be usable for the next small region (S232). g″ₜ (t: 0 to 23) is set.

Counting processing for determining whether the small region is a small region that is sequentially the same is performed (S234). The number of pixels that are not the same in value between the feature f″ₜ of the small region after the mask processing and a feature g″ₜ of the previous small region is counted, and the number is denoted by z.

In a case where z≤β2 holds and bits other than the predetermined bit number α2 of lower bits representing the features in the small region to be processed are the same, it is regarded that the features are the same, and then, a comparison is made with a small region including identical values and it is determined that the number of pixels that are different in the features is equal to or less than the threshold β2, and it is determined that the small region is a small region that is sequentially the same (S236). A sequential flag is set to 1.

In a case where the sequential flag is 1, the processing is skipped (S238). The result of the previous convolution processing is used as it is. It is only necessary to retain the result of the previous convolution processing (4×2 =8 values) every time, and read that data to obtain the result of the convolution processing in a case where the sequential flag is 1, and it is possible to acquire the operation result only by reading the data, without an actual product-sum operation.

In a case where both the identical value flag and the sequential flag are 0, the processing cannot be skipped, and thus a product-sum operation is performed in the arithmetic circuit 18 as usual so that the result of the convolution processing is obtained.

Note that other configurations and operations of an image processing device

according to the second embodiment are similar to those in the first embodiment, and thus description thereof is omitted.

As described above, when performing convolution processing for each small region of the input feature map, the image processing device according to the second embodiment does not perform convolution processing for the small region in a case where the features constituting the small region correspond to a small region including identical values or correspond to the features in the previously processed small region, and outputs, as a processing result for the small region, the result of processing on the small region including identical values determined in advance or the result of the previous processing. As a result, processing using a neural network including convolution processing can be speeded up.

Furthermore, in small region determination, after mask processing, the number of pixels that are different in the features in the small region is counted, and whether the counted number of pixels corresponds to a small region including identical values or a small region that is sequentially the same is determined on the basis of whether the counted number of pixels is equal to or less than a threshold, and thus arithmetic circuits for comparison and the amount of internal memory for data storage can be reduced. For example, in an 8-bit feature map, in a case where small region determination is also performed for 8 bits and in a case where small region determination is performed with lower bits masked, whether the bits coincide with each other in determination on whether the small region is a small region including identical values and determination on whether the small region is a small region that is sequentially the same is determined with less AND circuits.

In addition, for determination on whether the small region is a small region including identical values, it is necessary to retain a result for each value as a table. For example, in an 8-bit feature map, in a case where determination on whether the small region is a small region including identical values is also performed for 8 bits, 256 levels from 0 to 255 can be taken as an input value of a small region including identical values. In a case where determination on whether the small region is a small region including identical values is performed for 4 bits, an input value of a small region including identical values may be in only 16 levels from 0 to 15, and the amount of memory for a table for determining whether the small region is a small region including identical values can be greatly reduced.

### Third Embodiment

A third embodiment is different from the first embodiment in that convolution processing is performed in parallel on a plurality of small regions in an arithmetic circuit.

### <Overview of Third Embodiment>

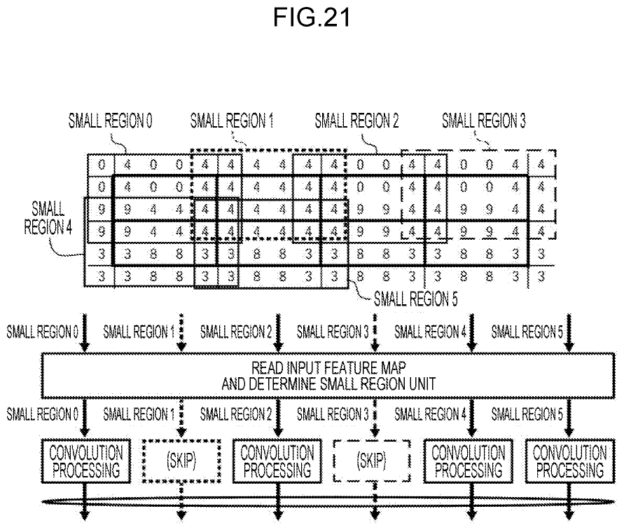

In the third embodiment, as illustrated in FIG. 21, an arithmetic circuit performs convolution processing on a plurality of small regions of an input feature map in parallel. FIG. 21 illustrates an example in which the arithmetic circuit sets the size of the small regions of the input feature map to 6×4, performs convolution processing on four small regions in parallel, and simultaneously outputs the results of the convolution processing at 32 points.

At this time, for each small region, it is determined whether the small region is a small region including identical values or whether the small region is a small region that is sequentially the same. In the example in FIG. 21, small region 1 is a small region including identical values, small region 3 is a small region that is sequentially the same, and convolution processing of small region 1 and small region 3 is skipped. Furthermore, convolution processing is performed on small region 0, small region 2, small region 4, and small region 5 in parallel, and as a result, processing results for six small regions are obtained at a time.

In this manner, by determining, for each small region, whether the small region is a small region including identical values or is a small region that is sequentially the same, and performing convolution processing on a plurality of small regions in parallel using an arithmetic circuit, it is possible to increase the probability that a region is a small region including identical values and the probability that a region is a small region that is sequentially the same, and to increase the probability of skipping the convolution processing.

### <Configuration of Image Processing Device According to Third Embodiment>

An image processing device according to the third embodiment will be described. Parts having configurations similar to those in the first embodiment are denoted by the same reference numerals, and description thereof is omitted.

The hardware configuration of an image processing device 210 according to the third embodiment is similar to the hardware configuration of the image processing device 10 illustrated in FIG. 7 described above.

An arithmetic circuit 18 of the image processing device 210 receives small region data of the input feature map and a kernel, repeatedly performs convolution processing on a predetermined number of small regions in parallel, and outputs an output feature map that is a result of convolution processing of each point in each small region.

A processing unit 32 of a learning unit 20 processes a target image using a neural network including convolution processing. When performing the convolution processing, the processing unit 32 performs the convolution processing for each small region obtained by dividing the input feature map to be an input of the convolution processing. The convolution processing for each small region is executed using the arithmetic circuit 18. At this time, the processing unit 32 determines, for each small region, whether the small region is a small region including identical values, and whether the small region is a small region that is sequentially the same. The small region data of the input feature map, the kernel, the determination result for each small region, and the preliminary calculation result table are input to the arithmetic circuit 18, and the output feature map is output from the arithmetic circuit 18.

Specifically, when performing the convolution processing, the processing unit 32 determines, for each small region, whether all the features constituting the small region correspond to a small region including identical values. In a case where it is determined that all the features constituting the small region correspond to a small region including identical values, the arithmetic circuit 18 does not perform convolution processing for the small region, and outputs, as a processing result for the small region, a result of processing performed for a case where all the features constituting the small region have the identical values, the result being stored in the preliminary calculation result table.

Furthermore, the processing unit 32 determines, for each small region, whether the features constituting the small region correspond to the features in the previously processed small region. In a case where it is determined that the features constituting the small region correspond to the features in the previously processed small region, the arithmetic circuit 18 does not perform convolution processing for the small region, and outputs a result of processing on the previously processed small region as a processing result for the small region.

Furthermore, the arithmetic circuit 18 performs convolution processing in parallel for a predetermined number of small regions in which all the features constituting the small region do not correspond to a small region including identical values and do not correspond to the features in the previously processed small region.

The output feature map that is the result of the convolution processing performed for each small region as described above is input to the next layer of the neural network.

Similarly to the processing unit 32, a processing unit 42 of an inference unit 22 processes a target image using a neural network including convolution processing. When performing the convolution processing, the processing unit 42 performs the convolution processing for each small region obtained by dividing the input feature map to be an input of the convolution processing. The convolution processing for each small region is executed using the arithmetic circuit 18. At this time, the processing unit 42 determines, for each small region, whether the small region corresponds to a small region including identical values and whether the small region corresponds to a small region that is sequentially the same. The small region data of the input feature map, the kernel, the determination result for each small region, and the preliminary calculation result table are input to the arithmetic circuit 18, and the output feature map is output from the arithmetic circuit 18.

Specifically, similarly to the processing unit 32, the processing unit 42 determines, for each small region, whether all the features constituting the small region correspond to a small region including identical values when performing the convolution processing. In a case where it is determined that all the features constituting the small region correspond to a small region including identical values, the arithmetic circuit 18 does not perform convolution processing for the small region, and outputs, as a processing result for the small region, a result of processing performed for a case where all the features constituting the small region have the identical values, the result being stored in the preliminary calculation result table.

In addition, similarly to the processing unit 32, the processing unit 42 determines, for each small region, whether the features constituting the small region correspond to the features in the previously processed small region. In a case where it is determined that the features constituting the small region correspond to the features in the previously processed small region, the arithmetic circuit 18 does not perform convolution processing for the small region, and outputs a result of processing on the previously processed small region as a processing result for the small region.

Furthermore, the arithmetic circuit 18 performs convolution processing in parallel for a predetermined number of small regions in which all the features constituting the small region do not correspond to a small region including identical values and do not correspond to the features in the previously processed small region.

The output feature map that is the result of the convolution processing performed for each small region as described above is input to the next layer of the neural network.

### <Operation of Image Processing Device According to Third Embodiment>

Next, an operation of the image processing device 210 according to the third embodiment will be described.

Processing similar to the learning processing illustrated in FIG. 11 described above is performed by a CPU 11 of the image processing device 210 reading a learning processing program from a ROM 12 or a storage 14, loading the learning processing program in a RAM 13, and executing the learning processing program. Furthermore, learning data is input to the image processing device 210.

In step S102 described above, arithmetic processing of each layer of the neural network is performed. Here, the arithmetic processing in a convolutional layer is achieved by the processing routine illustrated in FIG. 12 described above.

In step S116, in a case where features constituting a small region to be processed correspond to a small region including identical values, the arithmetic circuit 18 does not perform convolution processing for the small region to be processed, and outputs, as a processing result for the small region to be processed, a result of processing performed for a case where the features constituting the small region have the identical values stored in the preliminary calculation result table.

Furthermore, in a case where the features constituting the small region to be processed correspond to the features in a previously processed small region, the arithmetic circuit 18 does not perform convolution processing for the small region to be processed, and outputs a result of processing on the previously processed small region as a processing result for the small region to be processed.

Furthermore, the arithmetic circuit 18 performs convolution processing in parallel for a predetermined number of small regions in which the features constituting the small region do not correspond to a small region including identical values and do not correspond to the features in the previously processed small region.

Processing similar to the image processing illustrated in FIG. 17 described above is performed by the CPU 11 of the image processing device 210 reading an image processing program from the ROM 12 or the storage 14, loading the image processing program in the RAM 13, and executing the image processing program. Furthermore, a target image is input to the image processing device 210.

In step S122 described above, arithmetic processing of each layer of the neural network is performed. Here, the arithmetic processing in a convolutional layer is achieved by the processing routine illustrated in FIG. 12 described above.

Note that other configurations and operations of the image processing device 210 according to the third embodiment are similar to those in the first embodiment, and thus description thereof is omitted.

As described above, in the image processing device according to the third embodiment, the arithmetic circuit is configured to perform convolution processing for a plurality of small regions in parallel, and when convolution processing is performed for each small region of the input feature map, in a case where the features constituting the small region correspond to a small region including identical values or correspond to the features in the previously processed small region, convolution processing is not performed for the small region, and the result of processing on the small region including identical values determined in advance or the result of the previous processing is output as a processing result for the small region. As a result, even in a case where the bit depth or the parallel processing unit is large and skipping of convolution processing for a small region in which values of all features are zero cannot be expected, it is possible to expect speedup due to skipping of the processing without lowering the calculation accuracy or throughput.

Note that the present invention is not limited to the device configuration and the operational effects of the above-described embodiments, and various modifications and applications can be made without departing from the gist of the invention.

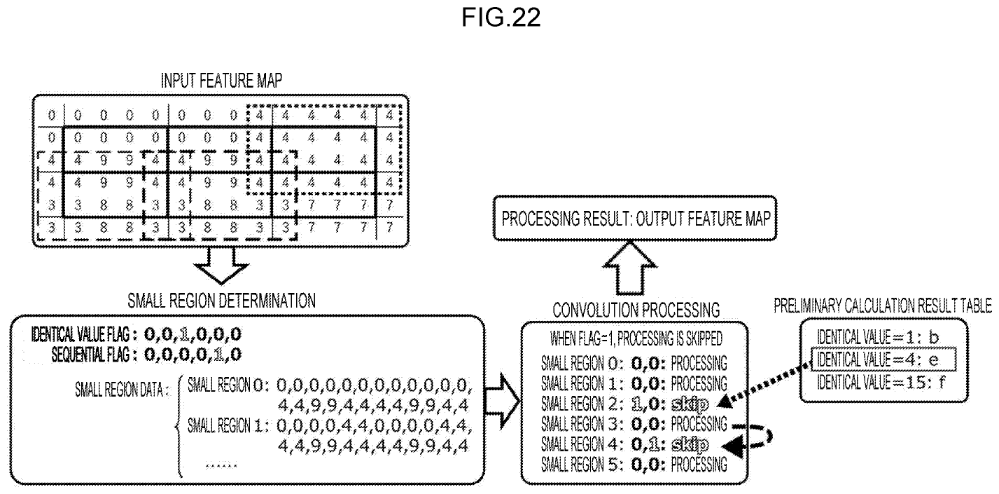

For example, the case where the processing result is calculated in advance for all of the values (for example, when the features are represented by 4-bit data, 16 values) for a small region including identical values and stored in the memory has been described as an example, but the present invention is not limited thereto. A value of a feature having a high probability of appearing as a small region including identical values may be determined in advance by performing simulation or the like, and the processing result for the small region including identical values may be obtained in advance only for values of top several features having a high appearance probability and be stored in the preliminary calculation result table (see FIG. 22). In the case of a small region including identical values whose processing result has been obtained in advance, the processing result obtained in advance is output without execution of convolution processing. FIG. 22 illustrates an example in which the processing result is obtained in advance only for a small region including identical values in which the value of the feature is 1, a small region including identical values in which the value of the feature is 4, and a small region including identical values in which the value of the feature is 15. Furthermore, since the processing result is 0 for a small region including identical values in which the value of the feature is 0, the processing result for the small region is not stored in the preliminary calculation result table. As a result, the size of the preliminary calculation result table in which the processing results obtained in advance are stored can be reduced, leading to reduction of the memory amount of hardware.

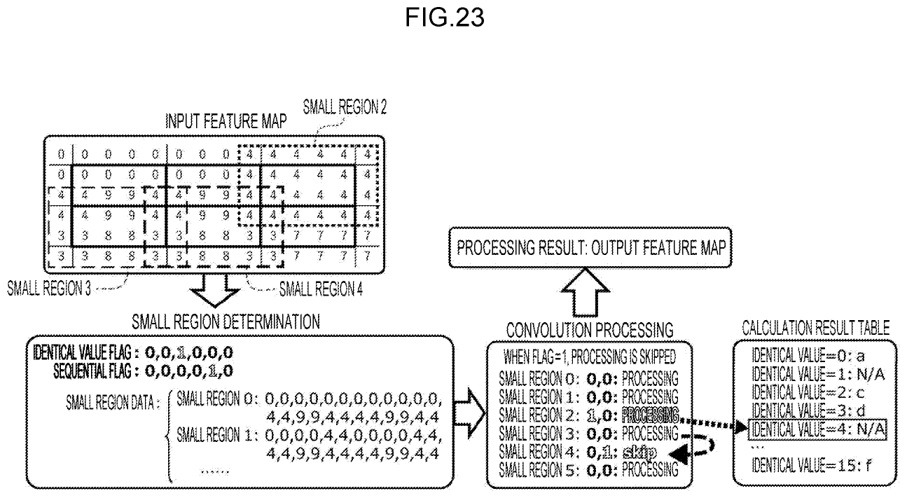

Furthermore, the case where the processing result is calculated in advance for all of the values (for example, when the features are represented by 4-bit data, 16 values) for a small region including identical values and stored in the memory has been described as an example, but the present invention is not limited thereto. When a small region including identical values in which the value of the feature is a certain value appears for the first time, convolution processing may be performed and the processing result may be stored in a calculation result table, and when a small region including identical values in which the value of the feature is the certain value appears for the second and subsequent times, the processing result may be read from the calculation result table without execution of convolution processing (see FIG. 23). FIG. 23 illustrates an example in which, in small region 2, a small region including identical values in which the value of the feature is 4 appears for the first time, convolution processing is performed, and the processing result is stored in the calculation result table. In this example, when the small region including identical values in which the value of the feature is 4 appears for the second and subsequent times, the processing result is read from the calculation result table without execution of convolution processing. Furthermore, the calculation result table is reset each time a layer is processed. As a result, the labor of preliminary calculation processing can be eliminated. Furthermore, since it is not necessary to transfer the preliminary calculation result of each layer from the RAM or the like to the internal memory of the arithmetic circuit for each layer, it is possible to reduce the amount of data transferred from the RAM or the like.

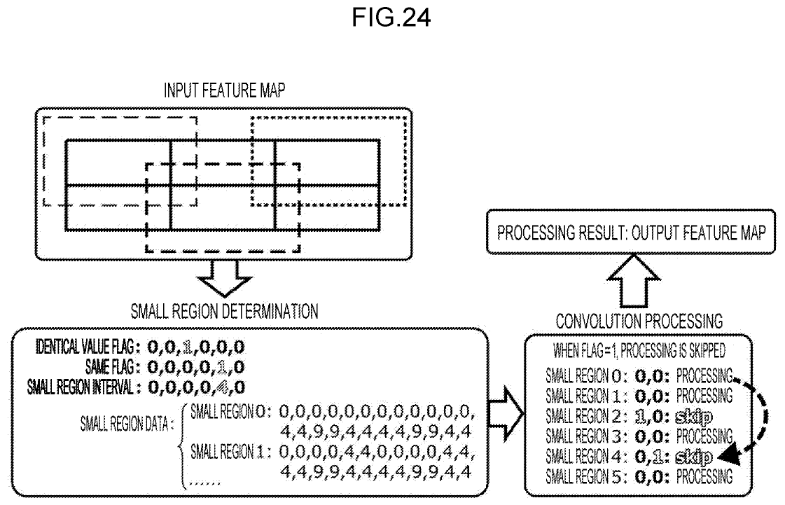

The case where it is determined whether a small region corresponds to a small region that is sequentially the same has been described as an example, but the present invention is not limited thereto. For example, it may be determined whether the small region is a small region corresponding to a small region that has been processed earlier, and in a case where the small region is a small region corresponding to a small region that has been processed earlier, the processing result of the small region that has been processed earlier may be output without execution of convolution processing (see FIG. 24). FIG. 24 illustrates an example in which it is determined that small region 4 corresponds to small region 1 by using not only a same flag indicating whether the small region corresponds to a small region that has been processed earlier but also a small region interval parameter indicating the number of the corresponding small region that has been processed earlier, and the same processing result as that of small region 1 is output without execution of convolution processing. In this case, it is necessary to set an upper limit of the small region interval and store, in the internal memory of the arithmetic circuit, processing results of small regions equivalent to the upper limit of the small region interval. As a result, the probability that the processing can be skipped increases, and thus, speedup can be expected.

The case of determining whether the small region corresponds to a small region including identical values has been described as an example, but the present invention is not limited thereto. It may be determined whether the small region corresponds to a predetermined feature pattern instead of a small region including identical values. For example, a processing result for a predetermined frequently appearing feature pattern may be obtained in advance, whether a small region corresponds to the predetermined frequently appearing feature pattern may be determined, and in a case where the small region corresponds to the predetermined frequently appearing feature pattern, the processing result obtained in advance may be output without execution of convolution processing.

Furthermore, the case where the image processing device includes the learning unit and the inference unit has been described as an example, but the present invention is not limited thereto. A device including a learning unit and a device including an inference unit may be configured as separate devices. In a case where the hardware restriction such as electric power or size is strong, it is preferable to configure the device including the learning unit and the device including the inference unit as separate devices. Examples thereof include a case where a device including an inference unit is mounted on a drone or used as an IoT or an edge device. The configuration in which one device includes a learning unit and an inference unit is generally used in a case where high-speed learning is performed using hardware installed in a data center as in cloud computing.

Various types of processing executed by the CPU reading and executing software (program) in the above embodiments may be executed by various processors instead of the CPU. Examples of the processors in this case include a programmable logic device (PLD) of which a circuit configuration can be changed after the manufacturing, such as a field-programmable programmable gate array (FPGA), and a dedicated electric circuit that is a processor having a circuit configuration exclusively designed for executing specific processing, such as an application specific integrated circuit (ASIC). Furthermore, the learning processing and the image processing may be executed by one of these various processors, or may be executed by a combination of two or more processors of the same type or different types (for example, a plurality of FPGAs, or a combination of a CPU and an FPGA). More specifically, a hardware structure of the various processors is an electric circuit in which circuit elements such as semiconductor elements are combined.

Furthermore, in the above embodiments, the aspect in which the learning processing program and the image processing program are stored (installed) in advance in the storage 14 has been described, but the present invention is not limited thereto. The programs may be provided by being stored in a non-transitory storage medium such as a compact disk read only memory (CD-ROM), a digital versatile disk read only memory (DVD-ROM), or a universal serial bus (USB) memory. Alternatively, the programs may be downloaded from an external device via a network.

Regarding the above embodiments, the following supplementary notes are further disclosed.

### Supplementary Note 1

An image processing device including a neural network including convolution processing for an image, the image processing device including:
a memory; and
at least one processor connected to the memory,
in which the processor is an image processing program for executing:
acquisition of a target image to be processed; and
processing of the target image using the neural network including the convolution processing,
wherein, when the convolution processing is performed, the convolution processing is performed for each small region obtained by dividing an input feature map to be an input of the convolution processing,
when the convolution processing is performed for each small region, in a case in which features constituting a small region correspond to a predetermined feature or a feature of a small region processed in the past, the convolution processing is not performed for the small region, and a result of processing for the predetermined feature or a result of processing in the past is output as a processing result for the small region,
wherein the small region corresponding to the predetermined feature is small region in which a difference from the predetermined feature is equal to or less than a threshold, and
wherein the small region corresponding to a feature of a small region processed in the past is a small region in which a difference from the feature of the small region processed in the past is equal to or less than a threshold.

### Supplementary Note 2

A non-transitory storage medium storing a computer executable program including a neural network including convolution processing for execution of image processing,
in which the image processing is an image processing program for executing:
acquisition of a target image to be processed; and
processing of the target image using the neural network including the convolution processing,
when the convolution processing is performed, the convolution processing is performed for each small region obtained by dividing an input feature map to be an input of the convolution processing,
wherein, when the convolution processing is performed for each small region, in a case in which features constituting a small region correspond to a predetermined feature or a feature of a small region processed in the past, the convolution processing is not performed for the small region, and a result of processing for the predetermined feature or a result of processing in the past is output as a processing result for the small region,
wherein the small region corresponding to the predetermined feature is a small region in which a difference from the predetermined feature is equal to or less than a threshold, and
the small region corresponding to a feature of a small region processed in the past is a small region in which a difference from the feature of the small region processed in the past is equal to or less than a threshold.

### REFERENCE SIGNS LIST

10, 210 Image processing device
11 CPU
13 RAM
18 Arithmetic circuit
20 Learning unit
22 Inference unit
30, 40 Acquisition unit
32, 42 Processing unit
34 Update unit

1. An image processing device including a neural network that can perform convolution processing for an image, the image processing device comprising:
a memory; and
at least one processor coupled to the memory, the at least one processor being configured to:
acquire a target image to be processed; and
process the target image using the neural network that can perform the convolution processing,
wherein the processor, when performing the convolution processing, performs the convolution processing for each small region obtained by dividing an input feature map to be an input of the convolution processing,
wherein, when the convolution processing is performed for each small region, in a case in which features constituting a small region correspond to a predetermined feature or a feature of a small region processed in the past, the convolution processing is not performed for the small region, and a result of processing for the predetermined feature or a result of processing in the past is output as a processing result for the small region,
wherein the small region corresponding to the predetermined feature is a small region in which a difference from the predetermined feature is equal to or less than a threshold, and
wherein the small region corresponding to a feature of a small region processed in the past is a small region in which a difference from the feature of the small region processed in the past is equal to or less than a threshold.

2. The image processing device according to claim 1, wherein the small region in which the difference from the feature is equal to or less than the threshold is a small region in which a difference in feature for each pixel is equal to or less than a threshold.

3. The image processing device according to claim 2, wherein, in the small region in which the difference from the feature is equal to or less than the threshold, bits other than a predetermined bit number of lower bits are the same as the feature.

4. The image processing device according to claim 1, wherein the small region in which the difference from the feature is equal to or less than the threshold is a small region in which a number of pixels that are different in the feature is equal to or less than a threshold.

5. The image processing device according to claim 1, wherein the thresholds are determined in advance in such a way that the processing using the neural network has predetermined accuracy.

6. The image processing device according to claim 1, wherein the predetermined feature is that the features in the small region are the same.

7. An image processing method in an image processing device including a neural network that can perform convolution processing for an image, the image processing method comprising:
acquiring, a target image to be processed; and
processing, the target image by using the neural network that can perform including the convolution processing,
wherein, when the image processing device performs the convolution processing, the image processing device performs the convolution processing for each small region obtained by dividing an input feature map to be an input of the convolution processing,
wherein, when the convolution processing is performed for each small region, in a case in which features constituting a small region correspond to a predetermined feature or a feature of a small region processed in the past, the convolution processing is not performed for the small region, and a result of processing for the predetermined feature or a result of processing in the past is output as a processing result for the small region,
wherein the small region corresponding to the predetermined feature is a small region in which a difference from the predetermined feature is equal to or less than a threshold, and
wherein the small region corresponding to a feature of a small region processed in the past is a small region in which a difference from the feature of the small region processed in the past is equal to or less than a threshold.

8. A non-transitory storage medium storing a program executable by a computer, including a neural network that can perform convolution processing for an image, to perform image processing, the image processing comprising:
acquisition of a target image to be processed; and
processing of the target image using the neural network that can perform the convolution processing,
wherein, when the convolution processing is performed, the convolution processing is performed for each small region obtained by dividing an input feature map to be an input of the convolution processing,
wherein, when the convolution processing is performed for each small region, in a case in which features constituting a small region correspond to a predetermined feature or a feature of a small region processed in the past, the convolution processing is not performed for the small region, and a result of processing for the predetermined feature or a result of processing in the past is output as a processing result for the small region,
wherein the small region corresponding to the predetermined feature is a small region in which a difference from the predetermined feature is equal to or less than a threshold, and
wherein the small region corresponding to a feature of a small region processed in the past is a small region in which a difference from the feature of the small region processed in the past is equal to or less than a threshold.
